(19) United States
(12) Patent Application Publication
(10) Pub. No.: US 2024/0288315 A1
(43) Pub. Date: Aug. 29, 2024

(54) ASSEMBLY TO PROTECT A SENSING DEVICE

(71) Applicant: TDK Electronics AG, München (DE)

(72) Inventors: Jeremiah WELCH, FENTON, MI (US); Jason BLUME, MONROE TOWNSHIP, NJ (US); Carsten DEHOFF,, BERLIN (DE); Jordi BASIANA MARTÍ, BERLIN (DE)

(73) Assignee: TDK Electronics AG, München (DE)

(21) Appl. No.: 18/570,302

(22) PCT Filed: Mar. 10, 2022
(86) PCT No.: PCT/EP2022/056180

§ 371 Date: Dec. 14, 2023

(30) Foreign Application Priority Data
Jun. 16, 2021 (DE) 10 2021 115 573.8

(51) Int. Cl. G01K 1/08; F16L 59/02; G01K 1/143; G01K 13/02

(52) U.S. Cl. CPC G01K 1/08; F16L 59/029; G01K 1/143; G01K 13/02; G01K 2201/02

(57) ABSTRACT

Assembly to protect a sensing device including a pipe configured for transportation of a fluid, a sensing device arranged on a peripheral surface of the pipe and in thermal contact with the pipe and a protection element for protection of the sensing device against mechanical impacts and for thermal isolation of the device against the environment.

### CROSS-REFERENCE TO RELATED APPLICATIONS

The present application is the national stage entry of International Patent Application No. PCT/EP2022/056180, filed on Mar. 10, 2022, and published as WO 2022/263022 A1 on Dec. 22, 2022, which claims the benefit of priority of German Patent Application No. 10 2021 115 573.8, filed on Jun. 16, 2021, the disclosures of all of which are incorporated by reference herein in their entireties.

### FIELD OF THE INVENTION

The present invention relates to an assembly to protect a sensing device during measurement and during its transportation and further relates to an appropriate protection element.

### BACKGROUND OF THE INVENTION

Measuring a surface temperature in a high-temperature environment, as is usually the case with pipes in HVAC systems, places high demands on the equipment. The sensing device has to withstand high temperatures up to 200° C. and often also has to cope with high humidity and permanent vibrations, especially in automotive applications.

Typical applications of described sensing devices are engines or underbodies of motor vehicles.

It has hardly been considered so far and is therefore the task of further inventions how the sensing devices can be protected from environmental impacts such as ambient temperature, air flow and especially in motor vehicle applications the splashing of dirt and water.

It is one of the tasks of the present invention to solve the described problems at least partially.

### SUMMARY OF THE INVENTION

The current invention comprises in a first aspect an assembly to protect a sensing device. The sensing device may be configured to determine the temperature of a fluid.

The assembly comprises a pipe configured for the transportation of fluids. The assembly further comprises a sensing device arranged on a peripheral surface of the pipe. The sensing device is in thermal contact with the peripheral surface of the pipe.

The assembly further comprises a protection element for protection of the sensing device against mechanical impacts and for thermal isolation of the device against the environment.

The described assembly is configured to facilitate the restriction of tangential, longitudinal and radial movements of the sensing device along or around the pipe.

Furthermore, the protection element is configured to protect the sensing device by covering it, making the sensing device mechanically more robust.

Furthermore, the protection element is configured to protect the sensing device by covering the same from environmental debris and water droplets.

The protection element may comprise several layers protecting the sensing device against thermal influences of the environment, as for example convective heat and heat radiation. The protection element thermally isolates the sensing device.

Furthermore, the protection element may comprise layers with noise absorption properties which are configured to limit noise from the pipe, in particular from the fluid streaming in the pipe, which is audible in the environment.

The protection element may be configured to be water resistant. In a water resistant embodiment, the protection element may prevent water droplets from reaching a surface of the sensing device. In other embodiments which are not completely water resistant, the protection element may be configured thick enough as to temper water droplets penetrating the protection element accordingly, so that the water droplets do not have any impact to the temperature measured by the sensing device.

In an embodiment, the protection element encloses the pipe with the device arranged thereon. In particular, the device is arranged on the pipe. The protection element encloses both, the sensing device and at least the section of the pipe on which the device is arranged.

In particular, the protection element may be configured as a wrap, which is wrapped around the pipe with the device arranged thereon.

This configuration allows an automated installation process. Robotic manipulators can place a force to a first section of the protection element and the underlying sensing device when wrapping a second section of the protection element around the device or around the pipe with the mounted device.

In case of a manual manufacturing process, the first section of the protection element is pre-assembled with the sensing device followed by hand wrapping a second section of the protection element around the pipe and/or the device in a controlled manner.

The protection element may consist of a layer structure, which is additionally structured into different parts, wherein the layers may comprise different materials.

In an embodiment, at least one layer, referred to as a base layer, may be continuously configured in the whole protection element comprising every part of the element.

All additional layers are applied on this base layers or on layers applied thereon. The number of stacked layers is not limited.

The protection element is configured as a sheet comprising the said layers. This means that the dimensions of the sheet-shaped protection element in directions normal to the stacking direction are much bigger than the dimension of the sheet in the stacking direction of the layers.

The protection element and its layers are flexible and consist of flexible materials. Examples for these materials are textile or non-textile fabrics, foams or plastics and other organic materials.

In an embodiment, the sensing device is a temperature sensor. The temperature sensor may be configured to measure the temperature of the pipe surface.

The sensing device may be configured as a conventional temperature sensor with a known structure. In an embodiment, the temperature sensor is adapted for measuring the temperature of a pipe surface, especially the pipe surface of a pipe configured in an HVAC system.

In an embodiment, the sensing device or in particular the temperature sensor is mounted on the pipe by means of a fixation element.

The fixation element can be selected from a wide range of possible elements like metal clips, plastic clips, mechanical zip-ties or similar basic fixation elements etc.

In an embodiment, the pipe is arranged in an HVAC system. HVAC means heating, ventilation and/or air-conditioning. The pipe is configured as a pipe to transport liquid or gaseous fluids.

Heated fluids for heating or cooled fluids for air-conditioning temper the surrounding pipe. Therefore the outer peripheral pipe surface may have another temperature than the environment. The sensing device is configured to measure this temperature of the pipe surface.

The protection element covers at least the sensing device and the surrounding section of the pipe to protect the device and the surrounding section against mechanical impacts and to prevent damages and to thermally isolate said section to achieve correct measurement values.

In an embodiment, the protection element comprises two different parts. The parts may be connected along a fold.

A first part comprises an adhesive layer for fixing the protection element to the sensing device and a second part covers the full circumference of the pipe and the device which is arranged on the pipe. In particular, the second part is wrapped around the full circumference of the pipe and around the device in order to mechanically protect and thermally isolate the device. The protection element covers at least a section of the pipe adjacent to the sensing device.

The first part may comprise an adhesive layer, applied on the base layer, which is adhesively fixed to the sensing device, in particular to the temperature sensor.

The first part comprises a smaller surface area than the second part.

The second part comprehending with the first part at least by the base layer is wrapped around the device mounted on the pipe forming at least one cylindrically shaped wrap covering the device and the adjacent pipe section.

In this embodiment, the second part of the protection element may fit closely to or may directly about the outer surface of the pipe.

The protection element is wrapped around the pipe and the device in a direction tangential to the outer pipe surface.

The first part and the second part of the protection element may have different dimensions in a longitudinal direction of the pipe.

In the longitudinal direction the second part may be longer than the first part.

The second part may be wrapped multiple times around the pipe, thereby fully covering the device mounted on the pipe and protecting the device against environmental influences.

The second part may be wrapped around the pipe and the device as often as required to provide sufficient thermal isolation and protection against mechanical impacts.

In an embodiment the protection element is fixed to the pipe by an adhesive connection between an adhesive layer of the second part and the peripheral surface of the pipe.

The second part of the protection element may be wrapped several times around the pipe. These several windings of the wrapped protection element are fixed together by adhesive connections configured between the outer peripheral surface of each inner winding and an adhesive layer of a corresponding outer winding. The first winding of the protection element may fit closely and abut to the pipe surface and the device and sticks to the pipe by its adhesive layer.

The second part may also be wrapped around the first part and may be adhesively fixed to it.

In at least one embodiment, the protection element comprises a third different part preventing an adhesive layer of the second part to stick on the pipe. In particular the third part prevents an overlying section of the adhesive layer of the second part from sticking on the pipe. The overlying section lays over the third part. A protruding section may protrude above the third part.

The third part is configured between the first part and the second part of the protection element. The first and the third part may be connected along a fold. The third and the second part may be connected along a second fold. The two folds are configured at opposite ends of the third part. The first and the second part are not directly connected since the third part is configured between them.

The protection element may be configured as a single fabric comprising different parts and layers. The fabric may be cut into a customized shape defining the parts.

Each layer of the fabric may extend over the entire fabric comprising each part of the fabric.

In some embodiments, several layers may only be provided in specific parts.

At least one base layer may extent over the entire fabric. Additionally, optional protection and adsorption layers can be applied on the second part or on the entire fabric. An adhesive layer comprising an adhesive material may be applied opposite to the protection layer at least on the first and the second part.

In an embodiment, an adhesive layer is also applied on the second part. The adhesive layer on the third part, on the first part and on the second part may be one continuous adhesive layer. In this embodiment, another non-adhesive layer may be applied on the adhesive layer in the range of the second part to prevent the second part from sticking to the pipe. This non-adhesive layer may comprise the same materials as the base layer. Possible materials are for example flexible foams, textile fabrics, paper or plastics.

In an embodiment, the third part is closely fitted to the peripheral surface of the pipe, protecting the device mounted on the pipe and preventing it from movement.

Unwanted movement is prevented by the compression of the third part wrapped around the pipe and the device.

In an embodiment, the protection element is fixed to the pipe by an adhesive connection between the adhesive layer of the second part and a peripheral surface of the third part.

Since the second part is wrapped around the third part and is stuck to the third part, the protection element cannot be unwrapped and the compression is maintained keeping the protection element at its place.

In an embodiment, the third part may have a smaller length in a longitudinal direction than the second part. Therefore, the terminal parts of the second part standing over the third part are adhesively fixed to the peripheral surface of the pipe in order to fix the protection element to the pipe. In this case all movements of the protection element are inhibited.

In an embodiment, the first part comprises an adhesive layer which is stuck to the sensing device.

The first part fixes the protection element to the sensing device.

The first part may be configured to fix sub-components of the device mechanically together. The fixation is configured by applying the adhesive layer of the first part like an adhesive tape on adjacent components of the sensing device, which are only loosely connected before. In particular, the first part may fix the sensing device and the fixation element, e.g. a metal or plastic clip, together.

In an embodiment, the protection element comprises several layers stacked in a direction radial to the pipe surface, wherein a base layer different from the adhesive layers is consistently formed in all parts.

The layers may be configured as described before.

In an embodiment, the second part comprises a protection layer stacked on the base layer opposite to the adhesive layer and configured to protect the device against outer impacts.

Additionally to a first protection layer the second part of the protection element may comprise additional layers which may provide different functionalities. Possible functionalities comprise thermal insulation, suppression of noise, adsorption of mechanical impacts, protection against water and humidity etc.

In an embodiment, a single protection layer or the base layer itself can have all required functionalities. Therefore no additional protection layers may be required.

Another aspect of the invention concerns an assembly configured for the protection of a sensing device during transportation of the same.

The assembly comprises a sensing device and a protection element which is wrapped around the sensing device. The protection element comprises a first part fixed to the sensing device and a second part wrapped around the sensing device.

The protection element protects the sensing device against peripheral mechanical impacts. Furthermore, the protection element may provide thermal isolation of the sensing device.

The protection element may be configured as described above in the first aspect of the invention. The sensing device may also be configured as described above. The assembly comprising the protection element and the sensing device may be configured according to any embodiment described above. The protection element provides mechanical protection to the sensing device when packaged in a specific manner. In particular, the protection element is fixed to the sensing device at a first part by an adhesive layer. A second and an optional third part of the protection element are loosely wrapped around the sensing device.

The loose wrap is hold in shape by a fixation element. The fixation element may be a rubber ring, a clamp, a blister or a glue spot or a box configured to accommodate the assembly.

The second and the third part may comprise adhesive layers. In the described assembly the adhesive layers of these parts are covered by an additional non-adhesive layer.

The non-adhesive layer is configured to be removable. The non-adhesive layer may comprise a non-adhesive material like paper, textile fabric, plastics etc.

By arranging the sensing device in the described assembly blister trays can be eliminated during transportation and the sensing device is allowed to be shipped in bulk.

The protection element may be configured as a bandage with an arbitrary number of windings protecting the sensing device during transportation.

Another aspect of the invention concerns a protection element comprising two different parts.

A first part comprises a first adhesive layer, which is configured to be adhesively fixed to a sensing device.

A second part comprises a second adhesive layer, wherein the second part is configured to cover the device in order to protect the device against outer mechanical impacts and to thermally isolate the device against the environment.

The second part has a larger surface area than the first part. In particular, the second part may be wrapped around the device.

In an embodiment, the protection element comprises a third different part configured consistently between the first part and the second part and configured to be wrapped around the pipe with the device, wherein the second part is wrapped around a peripheral surface of the third part being adhesively fixed to the third part.

The protection element may be configured as described above in the first or the second aspect of the invention according to any embodiment described above.

### BRIEF DESCRIPTION OF THE DRAWINGS

In the following, the embodiments of the invention will be explained in more detail with reference to accompanied figures. Similar or apparently identical elements in the figures are marked with the same reference signs. The figures and the proportions in the figures are not scalable. The invention is not limited to the following embodiments. The figures show:

FIG. 1 shows a first embodiment of the protection element from a perspective view.

FIG. 2 shows a second embodiment of the protection element from a perspective view.

FIG. 3 shows the second embodiment of the protection element from a side view.

FIG. 4 shows the second embodiment of the protection element from a top view.

FIG. 5 shows a first embodiment of an assembly comprising the protection element, a sensing device and a pipe.

FIG. 6 shows a second embodiment of the assembly comprising the protection element, a sensing device and a pipe.

### DETAILED DESCRIPTION

The protection element may comprise a piece of fabric which is cut in a specified shape showing separate parts and comprising several layers.

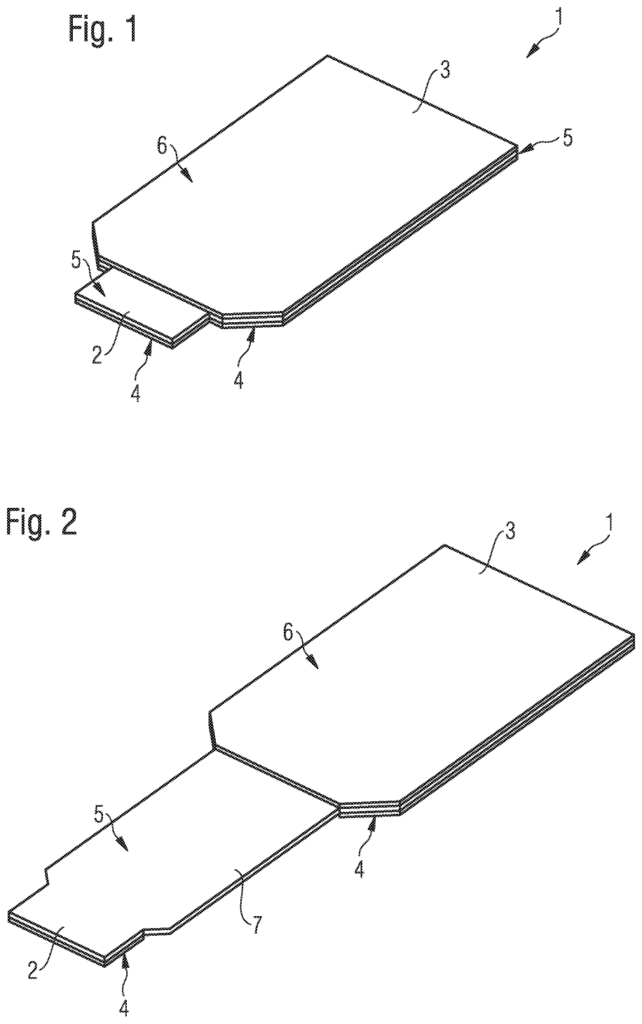

For example, the protection element 1 shown in FIG. 1 comprises two parts 2 and 3 and multiple layers.

The two parts are connected and manufactured from one piece of fabric. At least two layers are continuously formed in the whole fabric, a base layer 4 comprising a flexible material such as textile fabric, plastic or foam and an adhesive layer 5 applied on the base layer 4 and comprising an (organic) adhesive material.

In the example, the first part 2 shows a rectangular shape. The surface area of the first part 2 is significantly smaller than the surface area of the second part 3. The first part 2 is configured to be stuck to a sensing device. Thereby, the first part 2 is able to fix different loosely stacked sub-components of the sensing device together. In this case the adhesive layer 5 of the first part 2 works similar to an adhesive tape.

The second part 3 is configured to be wrapped around the device or a pipe with the device mounted on the pipe in a tangential direction. The first part 2 and the second part 3 are adjacently connected in the tangential direction.

The adhesive layer 5 of the second part 3 is configured to stick to the outer peripheral surface of the pipe thereby fixing the protection element 1 and the sensing device to the pipe.

In a longitudinal direction normal to the tangential direction, the second part 3 has a longer dimension than the first part 2. As the first part 2 is configured to be stuck to the sensing device, the second part 3 is configured to cover the whole sensing device and adjacent sections of the pipe.

Additionally, the second part 3 comprises at least one protection layer 6 applied on a side of the base layer 4 opposite to the adhesive layer 5.

The protection layer 6 protects the protection element 1 and thereby the sensing device from environmental mechanical impacts. Furthermore, the protection layer 6 may have noise suppressing, thermal isolating or similar functionalities. Possible functionalities of optional multiple protection layers 6 are described in detail below.

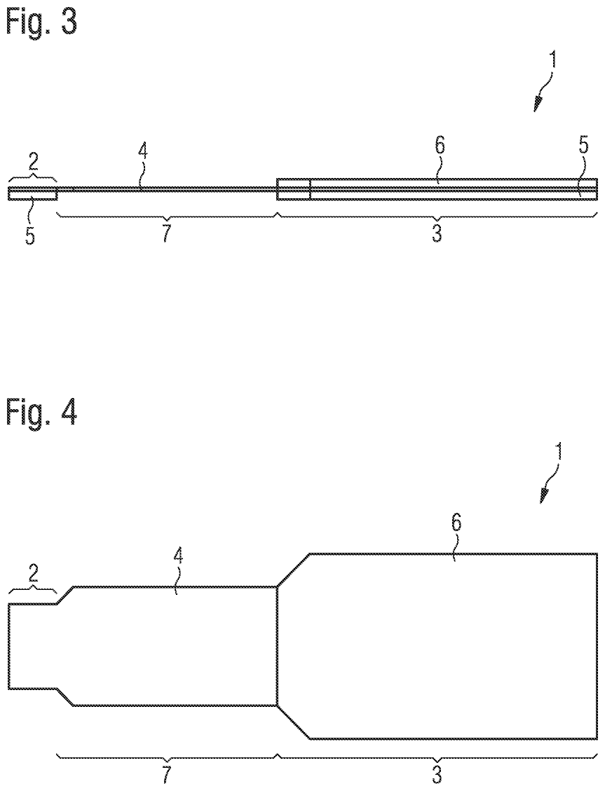

In FIGS. 2, 3 and 4, a second embodiment of the protection element 1 is shown from different views. The second embodiment is configured similar to the first embodiment. Only new features or features which are different are described in the following text.

Different to the first embodiment, the second embodiment of the protection element 1 comprises a third part 7 configured between the first and the second part 3 of the protection element 1.

The base layer 4 is still continuously formed throughout the whole protection element 1. Different to the first and the second part 3, in the third part 7 no adhesive layer 5 is applied on the base layer.

In further embodiments, an adhesive layer 5 may be applied on the third part 7 but may be covered by an additional non-adhesive layer. Therefore the third part 7 is not able to build adhesive connections with other non-adhesive surfaces.

The dimension of the third part 7 in a longitudinal direction is longer than the first part's but shorter than the second part's dimension.

After the fixation to the sensing device by the adhesive layer 5 of the first part 2, the third non-adhesive part can be wrapped around the device or the around pipe and the device in order to cover and protect the device.

In the next step, the second part 3 with its adhesive layer 5 is wrapped around the third part 7 and is adhesively fixed to the third part 7. The section of the second part 3 protruding above the third part 7 can be adhesively fixed to the pipe, thereby securing the protection element 1 to the pipe in a predetermined position.

The environment where sensing device is installed may be a protected part or may be subject to extreme conditions such as at the undercarriage or in the engine of an automotive vehicle.

In the latter case, there is a need to increase the mechanical protection of the sensing device for multiple reasons. For example the sensing device should be protected against airflow and debris such as small rocks, stick, water droplets etc.

The amount of wrapped material of the second and the third part 7 can be customized. In other words, the number of windings of the protection element 1 and the number of layers in the parts forming the windings and the thickness of each layer can be customized for the desired protection level and application.

In particular the second part 3 is a customizable part that can be increased in thickness or length (number of windings) and whose material can be swapped to provide different kinds and levels of protection.

For example the layers may provide mechanical protection and may act as a cover against debris including water droplets which could change the temperature measurements of the underlying sensing device.

A further application of the protection layers 6 in the second part 3 may be to reflect heat waves. Such heat waves may e.g. be generated from a nearby heat source. By reflecting the waves the protection layer 6 enables accurate temperature measurement of a temperature a fluid flowing through the pipe by means of measuring the thermally isolated surface of said pipe.

A customized thermal reflection layer may be coupled with thermal isolation effects.

Additionally, the wrapped windings of the second and/or the third part 7 provide thermal isolation.

In particular, the thermal conductivity of the adhesion layer of the second part 3 may be low enough and the thermal mass of the adhesion layer high enough that the enclosed sensing device is essentially thermally isolated from the environment such that the surface temperature of the pipe is majorly influenced by a fluid in the pipe and not by the ambient environment. The influence of air flowing across the outer surface of the protection element 1 can be ignored.

The temperature measured by the sensing device can then achieve an accurate measurement value of the surface temperature of the pipe as described before.

In applications or locations where audible vibrations can be transmitted and are of concern the outermost layer of the second part 3 may be a layer that incorporates noise absorption properties and limits the ambient audible noise that would otherwise not be prevented in that part of application.

In other embodiments, several noise cancelling layers may be provided.

In locations where the sensing device is visible, additional outer layers can be selected to allow desired functions of the end product integrator.

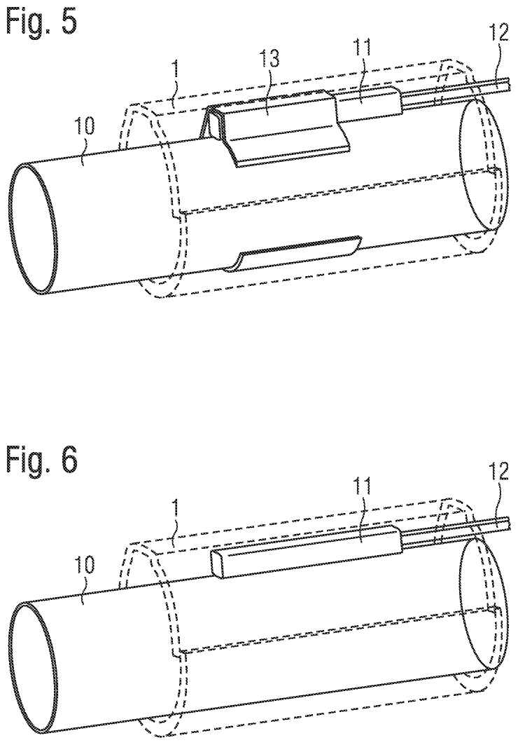

FIG. 5 shows a first embodiment of a temperature sensing application. On the pipe 10 a sensing device 11 is mounted. In the present example, the sensing device 11 is a temperature sensor. The sensing device 11 is electrically connected by an electrical conductor 12.

The temperature sensing device 11 is mounted to the pipe 10 by a metal clip 13. Instead the metal clip 13 plastic clips, mechanical zip-ties or any other base fixation mechanism may be used. The sensing device 11 and the clip 13 are only loosely put together.

To fix the loosely connected sensing device 11 and clip 13 together the first part 2 of the protection element 1 as shown in FIG. 1 or 2 is stuck to the sensing device 11 and the clip 13, fixing them together by its adhesive layer.

The metal clip 13 is clipped around the pipe 10 thereby radially fixing the sensing device 11 to the pipe 10. Without the protection element 1 wrapped around, the clip 13 and the sensing device 11 can still be moved along the pipe 10 in a tangential or a longitudinal direction.

The second part 3 and the third part 7 of the protection element 1 are wrapped around the pipe 10 with the device mounted thereon, thereby protecting the device and the adjacent section of the pipe 10 from environmental impacts.

Herein, the third part 7 is optional any may be configured only in specific embodiments. The third part 7 protects the underlying sensing device 11 and the pipe 10 from contact with adhesion material from the second part 3 which is not allowed in the thermal connection part around the sensing device 11.

Adhesive material may be not allowed in the thermal connection part because such material and debris that could become entrapped by the adhesive material can degrade the thermal connection between the sensing device 11 and the surface of the pipe 10 due to reducing a contact area in between and/or introducing an area of low thermal conductivity. This would degrade the thermal response time of the device as a whole.

Especially when serviceability is a requirement the introduction of the third part 7 is an option to provide a 360 degree protection from adhesion material around the sensing device 11 and the pipe 10.

An assembly configured accordingly could be easily removed or replaced by an operator without influencing the thermal connection between the sensing device 11 and the pipe 10.

In the wrapped configuration the second part's adhesive layer 5 is stuck to the third part 7 as described above. Since the second part 3 is longer in a longitudinal direction than the third part 7 it is also fixed adhesively to the pipe 10 surface at its protruding sections.

This adhesive bond limits linear movement of the underlying sensing device 11 as it blocks tangential and longitudinal travel paths of the sensing device 11.

In the same manner radial movement is blocked.

There are several advantages of providing an assembly of a temperature sensing device 11 which may be mounted on a pipe 10 and of a protection element 1 fixed together. The pipe 10 may be a pipe 10 for heating or cooling fluids and may be arranged in an HVAC system.

As a first advantage, the design responsibility of a customer is reduced.

Secondly, the tempering effect of air flow is eliminated as described before.

Furthermore, the thermal conductivity of the adhesion layer is low enough and its thermal mass high enough that the internally wrapped sensing device 11 is essentially thermally isolated from the environment.

The protection element 1 eliminates the surface convection on an outer surface of the sensing device 11.

Further, the thermal influence of water droplets is significantly reduced since no direct water droplet contact with the sensing device 11 is possible.

The water droplets would have to saturate the protection element 1. During this time period, the water droplets change their temperature before reaching the surface of the temperature sensor.

In some embodiments, the protection element 1 comprises even waterproof layers and an umbrella effect can be realized.

In a second embodiment of the assembly similar to the first embodiment and shown in FIG. 6, the metal clip 13 is omitted. Alternately, also another means of fixation like a plastic clip or a rubber ring can be used as mentioned above.

In this second embodiment the sensing device 11 is merely fixed by the fixation element to the pipe 10.

In another aspect of the invention, an assembly comprises a sensing device 11 and a protection element 1 but no pipe.

This assembly can, for example, be used to ship the sensing device 11.

Similar to the embodiments discussed before, in this assembly the first part 2 of the protection element 1 is stuck adhesively to the sensor eventually fixing sub-components of the sensor together.

In this case the sensing device 11 can be supplied with the protection element 1 pre-assembled by the adhesive layer 5 of the first part 2. This adhesive layer 5 fixes sub-components of the temperature sensor together as it provides a holding force in terms of sheer force and peel adhesion between the adhesive part and each individual component.

Additionally, after the first part 2 has been fixed to the sensing device 11 the remaining section of the protection element 1 is radially wrapped around said device removing access for entanglement of said devices with one another and providing cushioning properties to each individually wrapped device.

The strength of the fixation of the sensing device 11 is then defined by the adhesion between the sub-components and the adhesive layer 5 of the first part 2 on the one hand and by the tensile strength of the windings of the second and third part 7 of the protection element 1 on the other hand.

After the sensing device 11 has been wrapped in such a manner the position of the assembly can be assured by multiple means including but not limited to fixation by a glue dot, rubber-band or to embedding the assembly into a cavity of a blister tray designed to hold the wrap in place during transportation.

The described assembly of the recent aspect has advantages in the mounting process of said assembly on a pipe 10.

In the case of a manual mounting process, hand installation of a sensing device 11 is facilitated by the pre-assembled protection element 1 (fixed on the sensing device 11 by the adhesion layer of the first part 2). After the assembly comprising the sensing device 11 and the protection element 1 is fixed in a tangential orientation to the pipe 10 such pre-fixation facilitates the hand wrapping of the second and third part 7 in a controlled manner.

In the case of an automated process, the first part 2 is defined as the starting point of the wrapping process. Robotic manipulators can place a force on the first part 2 and the underlying sensing device 11, wrap the second and the optional third part 7 around the pipe 10 and can then place another force to these parts to activate a pressure-activated adhesive fixation.

This automation technique provides a controlled way to ensure that the pressure-activated adhesive layers are activated in all parts homogeneously.

1. An assembly to protect a sensing device comprising a pipe configured for transportation of a fluid, a sensing device arranged on a peripheral surface of the pipe and in thermal contact with the pipe and a protection element for protection of the sensing device against mechanical impacts and for thermal isolation of the device against the environment.

2. The assembly according to claim 1, wherein the protection element encloses the pipe and the device, which is arranged on the pipe.

3. The assembly according to claim 1, wherein the sensing device is a temperature sensor configured to measure the temperature of the pipe surface.

4. The assembly according to claim 1, wherein the pipe is arranged in a heating, ventilation or air conditioning system.

5. The assembly according to claim 1, wherein the protection element comprises two different parts:
a first part comprising an adhesive layer for fixing the protection element to the sensing device and a second part wrapped around the full circumference of the pipe and around the device arranged on the pipe.

6. The assembly of claim 5, wherein the protection element is fixed to the pipe by an adhesive connection between an adhesive layer of the second part and the peripheral surface of the pipe.

7. The assembly according to claim 5, wherein the protection element comprises a third different part which prevents an overlying section of an adhesive layer of the second part from sticking on the pipe.

8. The assembly according to claim 7, wherein the third part directly abuts the peripheral surface of the pipe.

9. The assembly according to claim 7, wherein the protection element is fixed to the pipe by an adhesive connection between the adhesive layer of the second part and a peripheral surface of the third part.

10. The assembly according to claim 5, wherein the first part comprises an adhesive layer which is stuck to the sensing device.

11. The assembly according to claim 10, wherein subcomponents of the device are mechanically fixed together by the adhesive layer of the first part.

12. The assembly according to claim 5, wherein the protection element comprises several layers stacked in a direction radial to the pipe surface, wherein a base layer different from the adhesive layers is consistently formed in all parts.

13. The assembly according to claim 12, wherein the second part comprises a protection layer stacked on the base layer opposite to the adhesive layer and configured to protect the device against outer impacts.

14. An assembly configured for the protection of a sensing device during transportation of the same, comprising the sensing device and a protection element, the protection element comprising a first part fixed to the sensing device and a second part wrapped around the sensing device for protection of the sensing device against mechanical impacts.

15. A protection element comprising two different parts: a first part comprising a first adhesive layer, which is configured to be adhesively fixed to a sensing device, and a second part comprising a second adhesive layer, wherein the second part is configured to be wrapped around the device for protection against outer mechanical impacts and for thermal isolation against the environment, wherein the second part has a larger surface area than the first part.

16. The protection element according to claim 15, wherein the protection element comprises a third different part configured consistently between the first part and the second part and configured to be wrapped around the device, wherein the second part is wrapped around a peripheral surface of the third part being adhesively fixed to the third part.
